(19) United States
(12) Patent Application Publication
(10) Pub. No.: US 2015/0155726 A1
(43) Pub. Date: Jun. 4, 2015

(54) MOBILE POWER PACK

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHAO DUAN, Shenzhen (CN); SHING-HUA CHIANG, New Taipei (TW)

(21) Appl. No.: 14/554,611

(22) Filed: Nov. 26, 2014

(30) Foreign Application Priority Data
Nov. 29, 2013 (CN) 201310620232.2

(51) Int. Cl. H02J 7/00; H01H 13/50

(52) U.S. Cl. CPC H02J 7/0042; H02J 7/0003; H01H 13/50

(57) ABSTRACT

A power button structure for a mobile power pack is disclosed, wherein the mobile power pack has a housing having a front end defining two output ports, an input port and a power button accommodating portion. The power button accommodating portion includes a receiving room, a hollow protrusion in the receiving room, and a recess below the receiving room. A power button has a shelled pressing portion and a U-shaped holding portion extending downwardly from the pressing portion. The pressing portion is attached to the hollow protrusion and when the pressing portion is pressed a contact switch which is located in front of the hollow protrusion is activated. The holding portion extends downwardly inside of the recess and is located between a front side wall and a rear side wall of the housing defining the recess.

### CROSS-REFERENCE TO RELATED APPLICATION

This application claims priority to Chinese Patent Application No. 201310620232.2 filed on Nov. 29, 2013, the contents of which are incorporated by reference herein.

### FIELD

The subject matter herein relates generally to a mobile power pack, and particularly to a power button structure for the mobile power pack, which is simple and reliable.

### BACKGROUND

Following the wide applications, such as gaming, video entertainment, internet browsing, of mobile devices such as smart phones and tablet computers, mobile power packs become more and more popular since running of the applications consume a lot of power, which may have the users need to charge the devices during a movement thereof.

In general, the mobile power pack has a power button, which after the mobile power pack and the mobile device are electrically connected together by a cable, is pressed to allow power of the mobile power pack to flow to the mobile device. The many power buttons have a complicated structure which may be difficult to assemble. In addition, some power buttons may become loose after repeated uses thereof, whereby the power button can lose its normal function to affect the usability of the mobile power pack.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present power button structure for a mobile power pack. Moreover, in the drawings, like reference numerals designate corresponding parts throughout the several views.

FIG. 1 is an isometric, exploded view of a mobile power pack in accordance with the present disclosure.

FIG. 2 is an enlarged, isometric view of a power button of the mobile power pack of FIG. 1.

FIG. 3 is an assembled view of the mobile power pack of FIG. 1.

FIG. 4 is a front part of a cross-sectional view taken along line IV-IV of FIG. 3.

FIG. 5 is a view similar to FIG. 4, with the power button being pressed rearwards.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

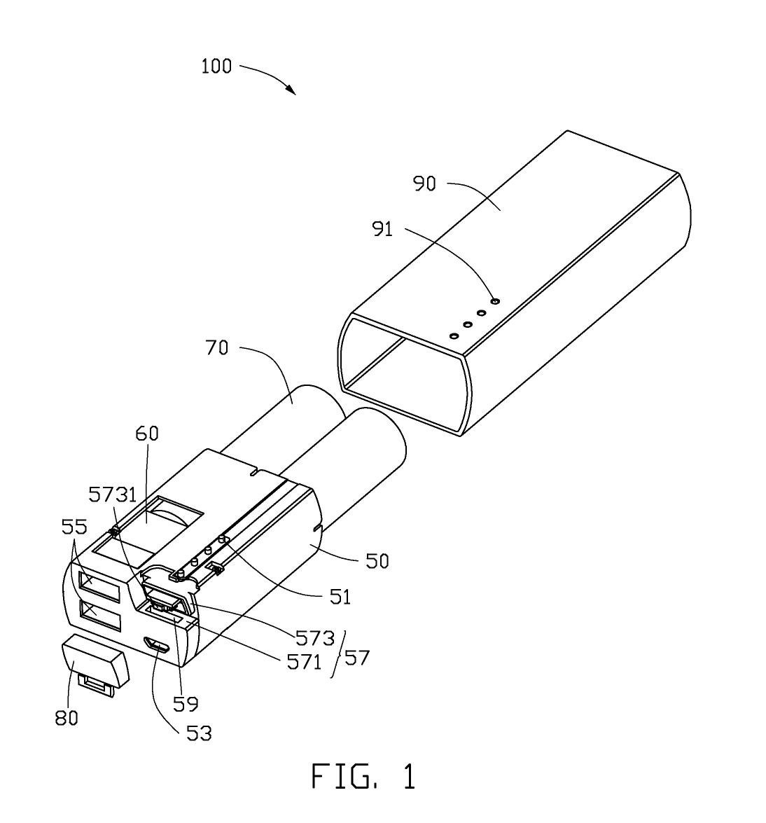

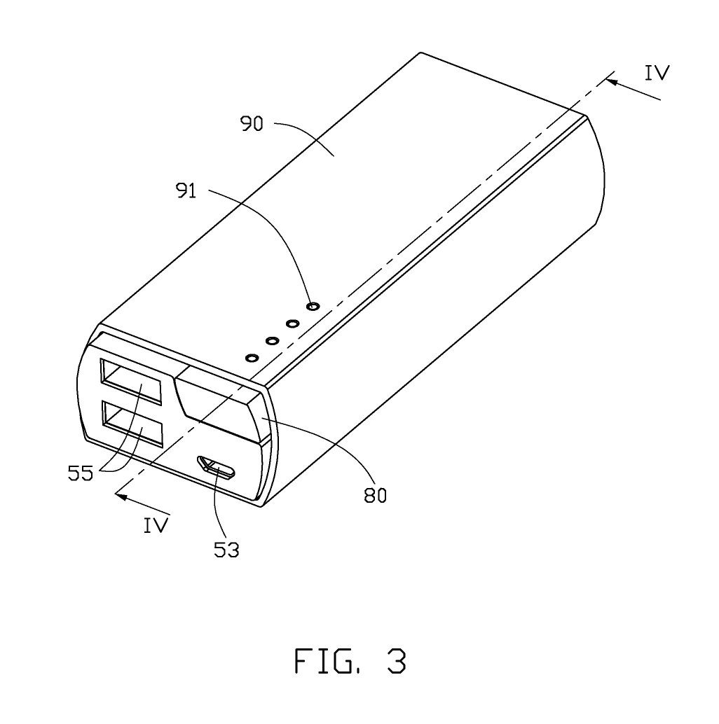

Referring to FIGS. 1 and 3, a mobile power pack 100 in accordance with the present disclosure generally is used for charging a mobile device (not shown) such as a mobile phone, particularly a smart phone or a tablet computer and includes a housing 50, a circuit board 60, two battery cells 70, a power button 80 and a casing 90. The circuit board 60 is accommodated in the housing 50. The battery cells 70 each have a first end adjacent to the circuit board 60 and a second end projecting away from the housing 50. The housing 50 together with the circuit board 60 and the battery cells 70 is received in the casing 90. The power button 80 is mounted in a first end of the housing 50 and protrudes outwardly beyond a first end of the casing 90.

The housing 50 is provided with multiple light indicators 51, such as four, each preferably being an LED (light emitting diode) indicator, an input port 53, two output ports 55, a power button accommodating portion 57 and a recess 59. The four light indicators 51 are arranged in a row along a lengthwise direction of the housing 50 and located at a lateral side of a top of the housing 50. The four light indicators 51 are electrically connected with the circuit board 60. The four light indicators 51 are used for indicating a power level of the battery cells 70. The input port 53 and the output ports 55 all are positioned in the first end of the housing 50 and electrically connected with the circuit board 60. In accordance with the preferred embodiment, the output ports 55 each are a USB (universal serial bus) port, and the input port 53 is a micro USB port. The input port 53 is located at a same lateral side of the housing 50 as the light indicators 51 and below the light indicators 51. The input port 53 is used for receiving power from an external power source to charge the battery cells 70 of the mobile power pack 100. The two output ports 55 are superposed over each other at the other lateral side of the housing 50. The two output ports 55 are used for transmitting power from the mobile power pack 100 to the mobile devices such as smart phones or tablet computers, wherein the two output ports 55 are used for two different systems, respectively; for example, one is for Apple® devices and the other is for Android® devices.

The power button accommodating portion 57 is provided in the first end of the housing 50 and located above the input port 53 and is configured for receiving the power button 80 therein. The power button accommodating portion 57 consists of a receiving room 571 and a protrusion 573 in the receiving room 571. The protrusion 573 generally is a hollow rectangle which receives a support (not labeled) for a contact switch 5731 therein. The contact switch 5731 is located in front of an inside of the hollow protrusion 573 and electrically coupled with the circuit board 60. To charge a mobile device, after a cable (not shown) is used to electrically couple one of the two output ports 55 and an input port of the mobile device, the contact switch 5731 is activated by exerting a pressing force thereon to close the contact switch 5731 whereby power in the battery cells 70 can flow through the contact switch 5731 to reach the mobile device.

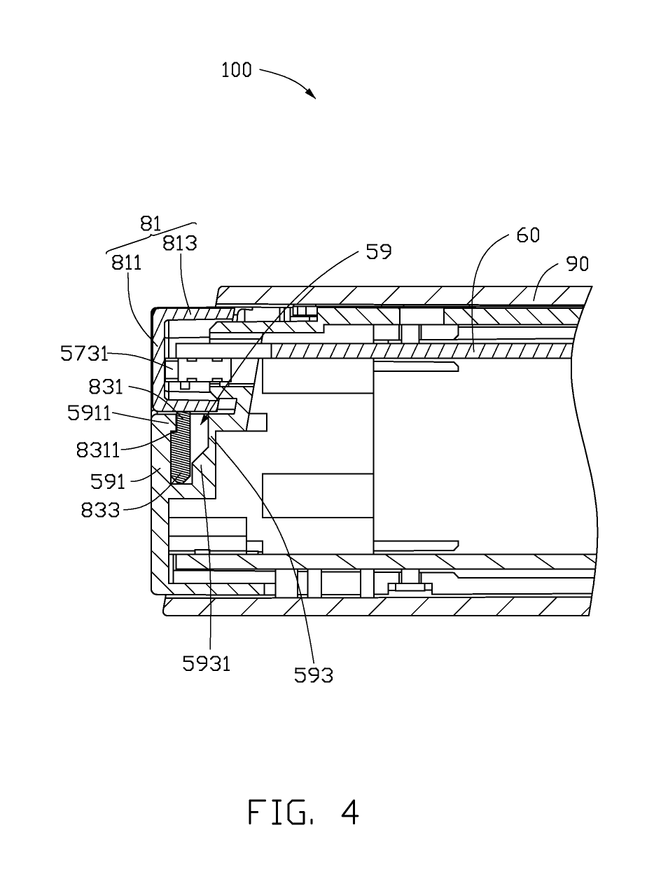

The recess 59 is defined in a wall (not labeled) defining a bottom of the receiving room 571 and is located below the receiving room 571 and the protrusion 573. A top of the recess 59 is in communication with the receiving room 571. The recess 59 is provided for securely mounting the power button 80 in the receiving room 571. Please referring to FIG. 4, the recess 59 is defined by opposite first side wall 591 and second side wall 593 of the housing 50. A top end of the first side wall 591 forms an engaging portion 5911 projecting rearwards toward the second side wall 593. The engaging portion 5911 is used for preventing a separation of the power button 80 from the recess 59. A lower part of the second side wall 593 forms a ramp platform 5931 towards the first side wall 591 for abutting and thereby fixing the power button 80 in position.

Referring back to FIG. 1, the battery cells 70 are electricity chargeable medium, which is electrically coupled to the circuit board 60 and is used for storing therein power from an external power source and supplying the power therefrom to a mobile device when the mobile device needs being charged. The battery cells 70 can be lithium-ion rechargeable battery cells or nickel-metal hydride rechargeable battery cells.

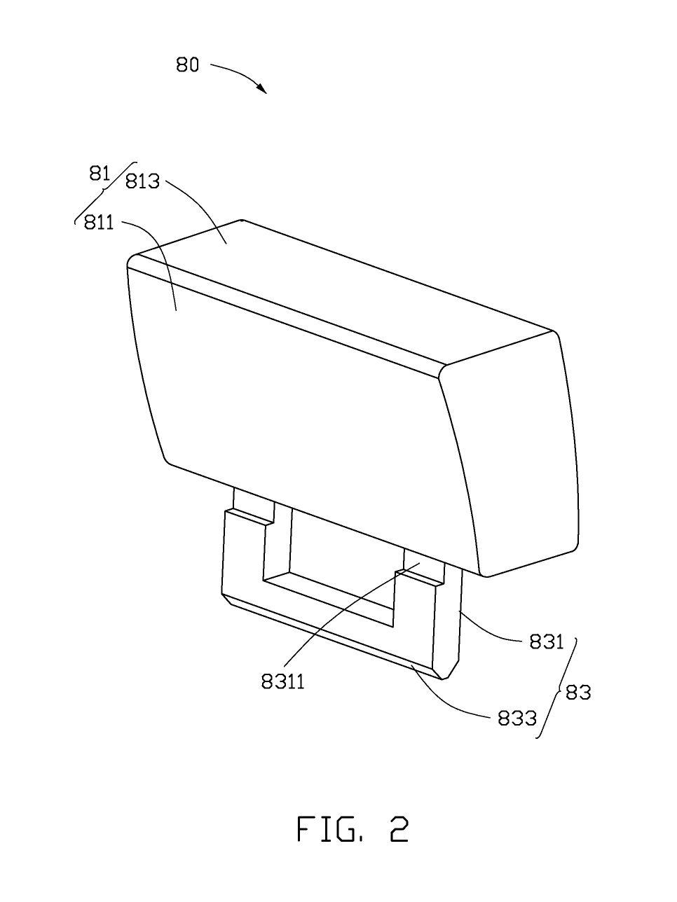

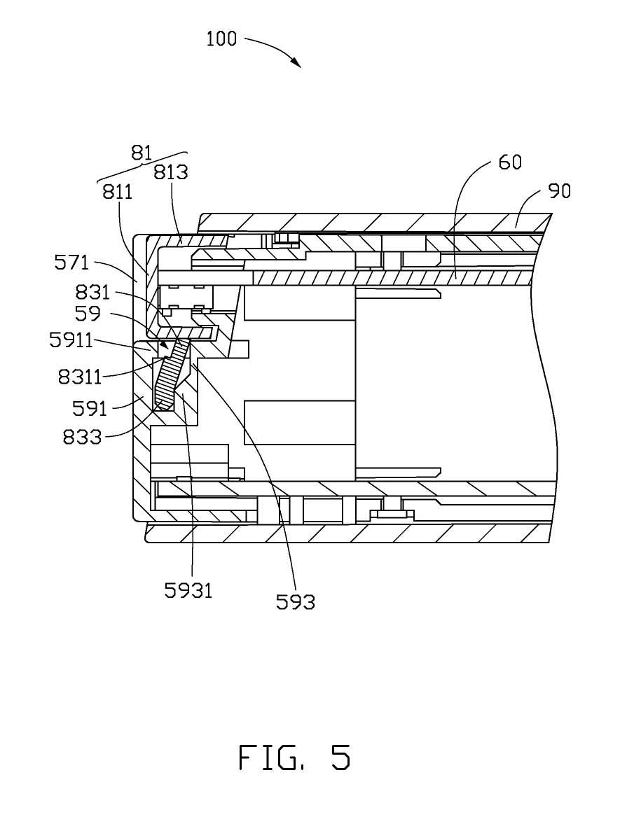

Referring to FIG. 2, the power button 80 is configured to be mounted in the power button accommodating portion 57 to facilitate the user to manipulate the contact switch 5731 to switch on or switch off the mobile power pack 100. The power button 80 is integrally formed by plastic injection molding and consists of a pressing portion 81 and a holding portion 83. The pressing portion 81 has a shelled configuration with a rear part thereof defining a cavity (not labeled) recessed forwardly (best seen in FIGS. 4 and 5). The pressing portion 81 includes a front pressing wall 811 and four peripheral walls 813 extending rearwards from four sides of the front pressing wall 811 to enclose the cavity. Each of the front pressing wall 811 and the four peripheral walls 813 has a substantially rectangular shape. The holding portion 83 is U-shaped, extends downwardly from a bottom one of the four peripheral walls 813 and consists of two cantilevers 831 extending substantially vertically downwardly from the holding portion 83 and an abutment 833 interconnecting two bottom ends of the two cantilevers 831. Each cantilever 831 defines a snap cavity 8311 in an upper end thereof. The snap cavity 8311 faces forwardly. The holding portion 83 is elastic and bendable relative to the pressing portion 81 within a predetermined range.

Referring to FIGS. 3 and 4, in assembly of the power button 80 and the housing 50, the pressing portion 83 is received in the power button accommodating portion 57 with the four peripheral walls 813 enclosing the protrusion 573 and the pressing wall 811 facing the contact switch 5731. The holding portion 83 is inserted into the recess 59 with the engaging portion 5911 of the first side wall 591 snapping into the snap cavities 8311 of the cantilevers 831, and the abutment 833 of the holding portion 83 sandwiched between a lower end of the first side wall 591 and the ramp platform 5931 of the second side wall 593, when the power button 80 is in its natural position, i.e., not pressed.

The casing 90 has a tubular configuration and defines four through holes 91 therein (FIG. 1). When the casing 90 sheathes the housing 50 therein, the four light indicators 51 are located in line with the four through holes 91, respectively, whereby light from the indicators 51 can emit outwardly to indicate the power level of the mobile power pack 100 (FIG. 2).

Referring to FIGS. 4-5, when the mobile power pack 100 is used to charge a mobile device, after they are electrically coupled together by a cable, the pressing portion 81 of the power button 80 is pressed rearwards toward the circuit board 60 to activate the contact switch 5731, as shown in FIG. 5. Accordingly power in the battery cells 70 can flow through the cable to charge the mobile device. At the same time, all or some of the light indicators 51 are lightened to indicate the power level in the battery cells 70 available for charging the mobile device. When the pressing portion 81 of the power button 80 is pressed, the cantilevers 831 of the holding portion 83 are driven by the pressing force to move toward the ramp platform 5931 of the second side wall 593. In the meantime, the cantilevers 831 are deformed to cause the snap cavities 8311 thereof to leave the engaging portion 5911 of the first side wall 591.

After the contact switch 5731 is activated to cause the mobile power pack 100 to start working, the pressing force on the pressing portion 81 of the power button 80 can be released. In the meantime, since the cantilevers 831 are elastically deformed between the engaging portion 5911 of the first side wall 591 and the ramp platform 5931 of the second side wall 593 due to the pressing force, the release of the pressing force from the pressing portion 81 causes the cantilevers 831 to restore to their original shape and position, whereby the power button 80 returns to its original position as shown in FIG. 4.

To stop the charging, the power button 80 can be pressed again to cause the contact switch 5731 to shift from the closed status to an open status.

If the pressing force on the pressing portion 81 of the power button 80 is too large, the cantilevers 831 will engage and be blocked by an upper end of the second side wall 593 defining the recess 59, whereby a further rearward movement of the cantilevers 831 of the holding portion 83 and accordingly the pressing wall 811 of the pressing portion 81 can be stopped. Thus, a possible damage of the contact switch 5731 in front of the hollow protrusion 573 by an undue pressure from the pressing wall 811 of the pressing portion 81 of the power button 80 can be avoided.

In the mobile power pack 100 in accordance with the present disclosure, by providing the power button 80 with the cantilevers 831 and the abutment 833, the cantilevers 831 with the snap cavities 8311, the housing 50 with the power button accommodating portion 57, the power button accommodating portion 57 with the recess 59, the recess 59 with the engaging portion 5911 and the ramp platform 5931 therein, and furthermore, by the engagement between the engaging portion 5911 and the cantilevers 831 defining the snap cavities 8311 and the engagement between the abutment 833 and the ramp platform 5931, the power button 80 can have a simple structure and can be reliably mounted to the housing 50. Furthermore, by the engagement between the cantilevers 831 and the second side wall 593, an undue movement of the pressing portion 81 of the power button 80 can be prevented to thereby protect the contact switch 5731 in front of the hollow protrusion 573 from being damaged due to an undue pressure acting thereon. Thus, the power button 80 and accordingly the mobile power pack 100 can have an extended period of life of use.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A mobile power pack for charging batteries comprising:
a housing defining a substantially open-ended space, the housing having a first end substantially opposite the open end of the defined space, and the first end defining an input port configured to receive an input jack and one or more output port with each output port configured to receive an output jack, and the housing first end further defining a button accommodating space;
an electrical switch positioned at least partially within the button accommodating space;
a movable power button accommodated at least partially within the button accommodating space, the power button is positionable to activate the electrical switch when in a first position and deactivate the electrical switch when in a second position;
a circuit board electrically coupled to the switch, the input port and each one or more output port;
a battery cell electrically coupled to the circuit board, a first portion of the battery cell at least partially received within the housing open-ended space with a second portion of the battery cell being opposite the first portion; and
a casing defining a substantially open-ended space, with the second portion of the battery cell at least partially received into the casing;
wherein, power from an external source is transferable to the battery cell through the input jack receivable by the input port and power from the battery cell is transferable through each output jack receivable by each output port;
wherein, activation of the electrical switch allows power to be transferred from the battery through at least one of the one or more output ports;
wherein, the button accommodating space further comprises a receiving room recess extending into the first end toward the housing open-ended space and a first end recess extending from the accommodating space into the housing;
wherein, the movable power button comprises a pressing portion with a holding portion extending from the pressing portion; and
wherein, the pressing portion of the movable button is positioned in the receiving room recess with the holding portion extending into the first end recess when the movable power button is in the second position.

2. The mobile power pack of claim 1, wherein the pressing portion has a shelled structure having a front pressing wall and a plurality of peripheral walls extending rearwards from the front pressing wall, and the holding portion extending downwardly from a bottom one of the peripheral walls and having a U-shaped configuration, the switch being activated by the pressing wall when it is pressed rearwards.

3. The mobile power pack of claim 2, wherein the housing forms a hollow protrusion in the receiving room recess, the switch is a contact switch and is received in the receiving room recess and located in front of an inside of the hollow protrusion.

4. The mobile power pack of claim 3, wherein the peripheral walls of the pressing portion encloses the hollow protrusion.

5. The mobile power pack of claim 4, wherein the housing comprises a first side wall and a second side wall adjacent opposite lateral sides of the first end recess, respectively, the holding portion comprises two cantilevers extending downwards from the bottom one of the peripheral walls of the pressing portion, and an abutment interconnecting bottom ends of the cantilevers, each cantilever defining a snap cavity, the first side wall forming an engaging portion which projects into the snap cavity when the power button is in the second position.

6. The mobile power pack of claim 5, wherein the second side wall forms a ramp platform projecting toward the first sidewall, the abutment being sandwiched between the first side wall and the ramp platform of the second side wall.

7. The mobile power pack of claim 6, further comprising a plurality of light indicators electrically coupled to the circuit board and provided for indicating a power level of the battery cell.

8. The mobile power pack of claim 7, wherein the casing sheathes the housing and the light indicators therein, the casing having an opened first end from which the input port, the one or more output port and the power button are exposed.

9. The mobile power pack of claim 8, wherein the power button is located in front of the open first end of the casing.

10. The mobile power pack of claim 9, wherein the one or more output port includes two output ports superposed over each other and located beside the power button and the input port, each output port being a USB (universal serial bus) port, the two output ports being configured for transferring power to two mobile devices having different operating systems, respectively.

11. The mobile power pack of claim 10, wherein the input port is located below the power button and is a micro USB port.

12. A button structure comprising:
a housing comprising a button accommodating portion having a receiving room, a protrusion in the receiving room, a recess below the receiving room, a front side wall in immediate front of the recess and a rear side wall in immediate rear of the recess;
a switch located in front of the protrusion; and
a button having a pressing portion and a holding portion extending downwardly from the pressing portion, the pressing portion having a shelled structure attached to the protrusion and the holding portion extending downwardly inside of the recess to be sandwiched between the front side wall and the rear side wall of the housing, the switch being activated when the pressing portion is pressed.

13. The button structure of claim 12, wherein the holding portion comprises at least a cantilever extending downwardly from the holding portion, the cantilever defining a cavity in a front side thereof, the front side wall projecting an engaging portion in the recess, the engaging portion engaging in the cavity when the pressing portion of the button is not pressed, the cavity leaving the engaging portion when the pressing portion is pressed to activate the switch.

14. The button structure of claim 13, wherein the holding portion is U-shaped and comprises two cantilevers and an abutment interconnecting bottom ends of the cantilevers, and wherein when the pressing portion is pressed to activate the switch the cantilevers engage the rear side wall of the housing.

15. The button structure of claim 14, wherein the rear side wall forms a ramp platform protruding forwardly toward the front side wall, and the abutment is sandwiched between the front side wall and the ramp platform.

16. The button structure of claim 15, wherein the protrusion is substantially a hollow rectangle, the switch being located in front of an inner space defined by the hollow portions.

17. The button structure of claim 16, wherein the switch is a contact switch which when once pressed switches from a status to another status.
